(19) United States
(12) Patent Application Publication
(10) Pub. No.: US 2016/0075091 A1
(43) Pub. Date: Mar. 17, 2016

(54) ADDITIVE MANUFACTURING OBJECT REMOVAL

(71) Applicant: Eastman Chemical Company, Kingsport, TN (US)

(72) Inventor: Kevin Michael Cable, Kingsport, TN (US)

(73) Assignee: EASTMAN CHEMICAL COMPANY, Kingsport, TN (US)

(21) Appl. No.: 14/487,518

(22) Filed: Sep. 16, 2014

(51) Int. Cl. B29C 67/00

(52) U.S. Cl. CPC B29C 67/0092; B33Y 10/00

(57) ABSTRACT

An object can be produced by depositing a material, layer-by-layer by an additive manufacturing process, onto a surface of a substrate. Removal of the object from the substrate may be accomplished without mechanically contacting the object with a device or chemically contacting the object. In an example, removal of the object from the substrate can be accomplished by flexing or bending the substrate. The substrate can be configured to elastically deform in response to a load applied to the sheet causing a deflection at a center of the sheet in an amount of at least about 12 mm and/or the sheet to have a radius of curvature that is less than or equal to about 305 mm.

### BACKGROUND

Additive manufacturing is a process used to produce three-dimensional (3D) objects. Additive manufacturing can be performed by extruding a flowable material through a nozzle of an extrusion head and depositing (typically layer-by-layer) the material onto a platform to form the object thereon. In some instances, the material used to form the layers of the 3D object may be referred to herein as “build material.” Extrusion-based additive manufacturing is sometimes called “fused deposition Modeling®” (FDM®), which is a trademark of Stratasys Ltd. of Edina, Minn., “fused filament fabrication” (FFF), or more generally, “3D printing.” An object can be digitally represented in 3D object data (e.g., a computer-aided design (CAD) model), which can be processed by an additive manufacturing system (e.g., a 3D printer) to form the object using the additive manufacturing process. Particularly, the digital representation of the object can be mathematically sliced into multiple horizontal layers. The additive manufacturing system can then generate a build path for each layer and use computer-control to move an extrusion head having a nozzle along the build path for each layer to deposit fluent strands or “roads” of the build material in a layer-by-layer manner onto a platform or a build substrate. For example, the additive manufacturing system can move an extrusion head/nozzle, the platform/build substrate, or both the nozzle and platform vertically and horizontally relative to each other to form the object. The build material from which the object is formed hardens shortly after extrusion to form a solid 3D object.

Common build materials used in extrusion-based additive manufacturing systems include polylactic acid (PLA) and acrylonitrile butadiene styrene (ABS), among others, which are typically supplied from filament spools to a hot end of the extrusion head where the filament is melted to a semi-liquid, flowable state and forced or extruded through the nozzle onto the platform. The substrate on which the build material is deposited is typically made of metal, glass, or plastic to provide adequate adhesion of the build material to the substrate. The adequate adhesion characteristics can minimize movement of the object during the formation of the object on one hand, and also allow the object to be removable after formation of the object on the other hand so that the substrate can be re-used for producing a subsequent object thereon. To this end, a variety of substrate surfacing materials (i.e., materials applied to the surface of the substrate) have been developed to facilitate separation of the object from the substrate after printing, those materials including painter's tape, glass, garolite, fiberglass, among others.

### SUMMARY

This summary is provided to introduce a selection of concepts for removing an object from a substrate, the object having been formed on the substrate using additive manufacturing. Additional details of example techniques, systems, and materials are further described below in the Detailed Description. This summary is not intended to identify key features or essential features of the claimed subject matter, nor is it intended for use in determining the scope of the claimed subject matter

An object can be produced by depositing a material, layer-by-layer according to a pattern, onto a surface of a substrate. The pattern in which the material is deposited may be based on three-dimensional (3D) model data that is accessed by an additive manufacturing system. Removal of the object from the substrate (dislodging the object) may be accomplished without mechanically contacting the object with a device (e.g., a tool such as a chisel, blade, etc.) or chemically contacting the object (e.g., chemically dissolving material at an interface between the object and the substrate). In an example, removal of the object from the substrate can be accomplished by flexing or bending the substrate, causing the object to dislodge, or “pop-off” of the substrate.

A preformed substrate can be removably mounted to a platform and the preformed substrate can have a surface including a first material having a first surface energy and a first Hildebrand solubility parameter. An object can be produced by forming one or more layers of a second material on the surface of the preformed substrate according to a pattern. The second material can have a second surface energy and a second Hildebrand solubility parameter, where a percent difference between the first Hildebrand solubility parameter and the second Hildebrand solubility parameter is at least about 5%, and where a percent difference between the first surface energy and the second surface energy is within about 10%. In some cases, the object can be removed from the preformed substrate by flexing the preformed substrate.

Additionally, a package can be provided that includes a number of items or components for use in an additive manufacturing process to form an object. One item included in the package may be a sheet configured to elastically deform in response to a load applied to the sheet causing a deflection at a center of the sheet in an amount of at least about 12 millimeters (mm) and/or causing a radius of curvature of the sheet to be less than or equal to about 305 mm. The package can further include an instruction for removing an additive manufactured object from the sheet without mechanically contacting the object with a device or chemically contacting the object. In an example, the instruction for removing the additive manufactured object comprises providing an instruction to flex the sheet in order to cause the object to dislodge from the sheet. In an example, the sheet may be a polymeric sheet having a thickness included within a range of about 0.7 mm to about 3 mm.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates example components of a first example additive manufacturing system.

FIG. 2 illustrates example components of a second example additive manufacturing system.

FIG. 3 illustrates a close-up, side view of multiple layers of an example object being deposited onto an example substrate during an additive manufacturing process.

FIG. 4. illustrates a partial perspective view of example components of an example additive manufacturing system showing a completed object that was formed on an example substrate using the example additive manufacturing system.

FIG. 5 illustrates a side elevation view of the substrate and the object of FIG. 4 showing an example technique for removal of the object from the substrate.

FIG. 6 is a flow diagram of an illustrative process of forming an object on a substrate using an additive manufacturing system and removing the object from the substrate.

FIG. 7 shows an object that was formed on a substrate using an additive manufacturing system.

FIG. 8 shows the object of FIG. 7 after the object has been removed from the substrate by an individual flexing two edges of the substrate with their hands.

FIG. 9 shows an object that was formed on a substrate using an additive manufacturing system and then subsequently removed from the substrate by prying the object from the substrate.

FIG. 10 shows an object that was formed on a substrate using an additive manufacturing system.

FIG. 11 shows the object of FIG. 10 after the object has been removed from the substrate by an individual flexing two edges of the substrate with their hands.

### DETAILED DESCRIPTION

The present disclosure is directed to, among other things, techniques, systems, and materials for removing an object from a substrate, the object having been formed on the substrate using an additive manufacturing system. An additive manufacturing process is the process of joining materials to make objects from digital 3D design data. Desirably, the additive manufacturing process used in the invention joins materials layer upon layer. One of the additive manufacturing processes useful in the invention is fused deposition modeling (FDM).

The object can be produced by depositing one or more layers of a material on a surface of the substrate according to a pattern, which may be based on 3D model data. Removal of the object from the substrate (dislodging the object) may be accomplished without physically contacting the object with a device (e.g., a tool such as a chisel, blade, a person's hand, etc.) or chemically contacting the object (e.g., chemically dissolving material at an interface between the object and the substrate, pre-treating the substrate with a release agent prior to forming the object on the substrate, etc.). In an example, removal of the object from the substrate can be accomplished by flexing or bending the substrate, causing the object to dislodge, or “pop-off” of the substrate. Flexing or bending of the substrate may be caused by force applied to the substrate from an individual (e.g., a person's hands) or a non-human object removal mechanism or machine. That is, in some instances, the process of removing the object from the substrate may be entirely machine-implemented, without human intervention.

It is to be appreciated that the object formed using the techniques, systems, and materials disclosed herein can be intended for any suitable application including, without limitation, modeling, rapid prototyping, production, and the like. The system used to create the object can be implemented in any suitable context including end-consumer systems, prosumer systems, or professional-grade additive manufacturing systems. For example, additive manufacturing systems such as extrusion-based 3D printers or FDM and materials for implementing the techniques disclosed herein can be manufactured and sold to consumers for at-home building of objects (e.g., “do-it-yourself” 3D printing kits, desktop 3D printers, packages including the substrate (e.g., a polymeric sheet) for use in 3D printers, and the like). A “package,” in this context, is meant to describe a container of items or components that are packaged for commercial sale to consumers and usable as, or with, an additive manufacturing system. For example, the package may contain a substrate or sheet usable in a 3D printing apparatus to form an additive manufactured object on the substrate. An “all-in-one” package may include other components of the additive manufacturing system as a bundled product offering, such as a 3D printer, build material filament, and a substrate that is to be used in the 3D printer to form objects thereon. Instructions may be included in, or on, the package as well (e.g., printed text on the package or on a slip of paper inside the package), instructing a consumer to use the packaged contents in the proper way.

Additionally, or alternatively, companies of any size can utilize the techniques disclosed herein by implementing additive manufacturing systems at their facilities to mass manufacture objects with high throughput so that the objects/products can be sold in the open market. Industries that can benefit from the techniques, systems, and materials disclosed herein include, without limitation, include cosmetics (e.g., cosmetic container manufacturing), beverage container manufacturing, product enclosure manufacturing, and so on.

The techniques and systems disclosed herein allow for the additive manufacturing of objects where a sufficient adhesion is achieved between the object and the substrate during formation of the object on a substrate, yet the completed objects are able to be removed from the substrate without external physical contact on the object. Furthermore, the physical properties and dimensions of the substrate are such that the substrate can be deformed (e.g., flexed) in a manner that the object can be removed from the substrate without external physical contact on the object.

Additive manufacturing systems have heretofore been unable to achieve optimal platform adhesion during object formation and to eliminate warping of the object during object formation while also facilitating easy removal of the object after it is produced on the substrate. In many situations, configuring an additive manufacturing system with desired adhesion characteristics at the interface between the substrate and the object can be complex and difficult to achieve. In particular, users of additive manufacturing systems can utilize various techniques to achieve greater adhesion of the object to the substrate, but, damage to the object can result upon removal of the object from the substrate. For example, an object can be adhered to a substrate such that an individual or machine may need to utilize techniques to remove the object from the substrate that can cause damage to the object and/or the substrate. To illustrate, a tool, such as a chisel or knife, or a chemical process may be used to remove an object from the substrate that cause unwanted damage (e.g., removal of portions of the object, removal of portions of the substrate, etc.).

The techniques and systems described herein can be implemented in a number of ways. Example implementations are provided below with reference to the following figures.

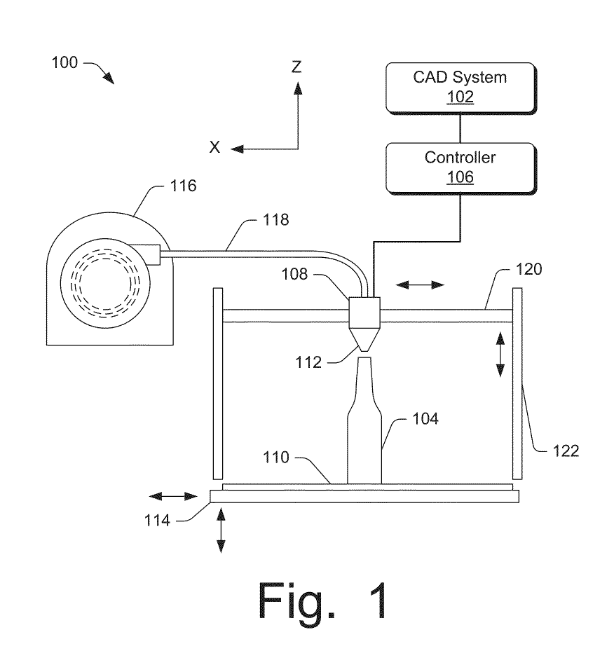

FIG. 1 illustrates example components of an example additive manufacturing system 100 (“system” 100). The system 100 can be configured to manufacture objects by utilizing additive manufacturing principles. In some instances, the system 100 be considered a fused deposition Modeling® (FDM®) system, a fused filament fabrication (FFF) system, or more generally, a 3D printing system (or 3D printer).

The system 100 can include a computer-aided design (CAD) system 102 to provide a digital representation of an object 104 to be formed by the system 100. Any suitable CAD software program can be utilized for the CAD system 102, such as Solidworks®, to create the digital representation of the object 104. For example, a user can design, using a 3D modeling software program (e.g., Solidworks®) executing on a host computer, the bottle-shaped object 104 shown in FIG. 1A that is to be manufactured using the additive manufacturing system 100.

In order to translate the geometry of the object 104 into computer-readable instructions or commands usable by a controller 106 in forming the object 104, the CAD system 102 can mathematically slice the digital representation of the object 104 into multiple horizontal layers. The CAD system 102 can then design build paths along which build material is to be deposited in a layer-by-layer fashion to form the object 104.

The controller 106 can manage and/or direct one or more components of the system 100, such as an extrusion head 108, by controlling movement of those components according to a numerically controlled computer-aided manufacturing (CAM) program along computer-controlled paths. The movement of the various components, such as the extrusion head 108, can be performed by the use of stepper motors, servo motors, and the like.

The controller 106 and the CAD system 102 can, in some cases, be parts of a single system that provides digital representations of the object 104 and controls the components of the system 100. The controller 106 can be implemented in any suitable hardware and/or software processing unit configured to execute computer-readable instructions or commands stored in computer-readable media for carrying out the techniques disclosed herein. In this sense, computer-readable media can include, at least, two types of computer-readable media, namely computer storage media and communication media. Computer storage media can include volatile and non-volatile, removable, and non-removable media implemented in any method or technology for storage of information, such as computer-readable instructions, data structures, program modules, or other data. The system memory, the removable storage and the non-removable storage are all examples of computer storage media. Computer storage media includes, but is not limited to, random access memory (RAM), read-only memory (ROM), erasable programmable read-only memory (EEPROM), flash memory or other memory technology, compact disc read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the controller 106. In contrast, communication media can embody computer-readable instructions, data structures, program modules, or other data in a modulated data signal, such as a carrier wave, or other transmission mechanism. As defined herein, computer storage media does not include communication media.

The extrusion head 108 can be configured to extrude build material onto a substrate 110 during the process of printing the object 104. The extrusion head 108 can be any suitable type of extrusion head 108 configured to receive material and to extrude the material through a nozzle 112 (or tip) that includes an orifice from which fluent strands or “roads” of the material can be deposited onto the substrate 110 in a layer-by-layer manner to form the object 104. In some cases, as material is supplied to the extrusion head 108, the material enters the extrusion head 108 where it is heated by a heating element inside the extrusion head 108 to a temperature that causes the material to become flowable. The temperature applied to the material in the extrusion head 108 can vary depending on the material being heated. For example, a first temperature can be applied to heat a first material and a second temperature can be applied to heat a second material.

The temperature applied to heat the material in the extrusion head 108 can be at least about 150° C., at least about 170° C., at least about 190° C., or at least about 210° C. The temperature applied to heat the material in the extrusion head 108 can also be no greater than about 350° C., no greater than about 300° C., no greater than about 280° C., no greater than about 260° C., or no greater than about 240° C. In an illustrative example, the temperature applied to heat the material in the extrusion head 108 can be included in a range of about 135° C. to about 360° C. In another illustrative example, the temperature applied to heat the material in the extrusion head can be included in a range of about 230° C. to about 290° C.

Additionally, the temperature applied to heat the material in the extrusion head 108 can be based on a glass transition temperature of the material. For example, the temperature applied to heat the material in the extrusion head 108 can be within about 2° C. of the glass transition temperature of the material, within about 5° C. of the glass transition temperature of the material, within about 8° C. of the glass transition temperature of the material, within about 14° C. of the glass temperature of the material, within about 20° C. of the glass transition temperature of the material, or within about 25° C. of the glass transition temperature of the material.

The substrate 110 can be positioned on a platform 114 that is configured to support the substrate 110. In this manner, the substrate 110 can be provided on the platform 114 as a “working surface” for building the object 104 on the substrate 110. The substrate 110 can be removably mounted, attached or fastened to the platform 114 by any suitable attachment mechanism including, without limitation, one or more bolts, clamps, hooks, latches, locks, nails, nuts, pins, screws, slots, retainers, adhesive, Velcro®, tape, or any other suitable attachment mechanism that allows for the substrate 110 to be secured to the platform 114 during the formation of the object 104, yet removable after the object 104 is formed. In some cases, suction can be applied to the substrate 110 to hold the substrate 110 in place during formation of the object 104. For example, one or more holes can be provided in the platform 114 and suction, or a vacuum, can be applied via the one or more holes to force the substrate 110 toward the platform 114. In some examples, mounting the substrate 110 on the platform 114 can include setting (laying or placing) the substrate 110 on the platform 114 without any additional securing mechanism.

The substrate 110 can be of any suitable shape and size that allows for the substrate 110 to be flexed or bent in a resilient manner for object removal, as will be described in more detail below. In the illustrative figures, the substrate 110 is shown as being a basic square shape having a substantially flat surface on which the object 104 is to be formed. However, any suitable shape, including, but not limited to, a rectangle, circle, triangle, trapezoid, or any other polygonal shape can be utilized for the substrate 110.

The substrate 110 can include a polymeric material. In some cases, the substrate 110 can include a coating of the polymeric material. In other instances, the substrate 110 can be made substantially of the polymeric material. In an example, the substrate 110 can include a thermoplastic polymer. The substrate 110 can also include a polyester. Additionally, the substrate 110 can include a glycol-modified polyethylene terephthalate. Further, the substrate 110 can include a copolymer. To illustrate, the substrate 110 can include a copolyester. The substrate 110 can also include polylactic acid, acrylonitrile butadiene styrene, a polycarbonate, a polyamide, a polyetherimide, a polystyrene, a polyphenylsulfone, a polysulfone, a polyethersulfone, a polyphenylene, a poly(methyl methacrylate), or a combination thereof.

During operation of the system 100, the substrate 110 can be initially positioned below the nozzle 112 of the extrusion head 108 in a direction along the Z-axis shown in FIG. 1 at a time prior to the first layer of build material being deposited. The distance at which the substrate 110 is spaced below the nozzle 112 can be any suitable distance allowing for the deposition of fluent strands or “roads” of build material at a desired thickness. In some instances, a distance between the substrate 110 and the nozzle 112 prior to deposition of the first layer of build material can be within a range from about 0.02 mm to about 4 mm. As layers of the object 104 are deposited, the extrusion head 108 can be moved a distance in increments in the Z-direction that allows for depositing a next layer of the object 104 at a desired thickness. In some examples, the incremented distance can be about 0.1 mm.

The system 100 further includes a build material supply 116 and a build material supply line 118 connecting the build material supply 116 to the extrusion head 108 for supplying the build material to the extrusion head 108 during the additive manufacturing process. The material supply 116 can include a material bay or housing containing a spool of build material filament that can be unwound from the spool by a motor or drive unit as the build material is supplied to the extrusion head 108, is heated therein, and is extruded through the nozzle 112. In some examples, supplying of the build material through the build material supply line 118 can be turned on or off, and the build material can be advanced in both forward and backward directions along the build material supply line 118. Retraction of the build material along the build material supply line 118 in a direction toward the build material supply 116 can be advantageous to prevent “drool” at the nozzle 112 and/or recycle unused build material after finishing an object. Moreover, the rate at which the build material is supplied to the extrusion head 108 can be controlled by the controller 106 or another processing unit to direct a drive unit (e.g., worm drive) at varying speeds so that speeds can be increased or decreased, and/or nozzles 112 of varying-sized orifices can be utilized for depositing roads of different thickness from the nozzle 112.

Filaments of the build material can have a diameter of at least about 0.5 mm, at least about 1 mm, at least about 1.5 mm, or at least about 2 mm. In addition, filaments of the build material can have a diameter no greater than about 7 mm, no greater than about 5 mm, no greater than about 3 mm, or no greater than about 2.5 mm. In an illustrative example, the diameter of filaments of the build material can be included in a range of about 0.2 mm to about 10 mm. In another illustrative example, the diameter of filaments of the build material can included in a range of about 1.7 mm to about 2.9 mm.

The nozzle 108 of the additive manufacturing system 100 can move along the rails 120, 122 at a speed of at least about 5 mm/second, at least about 10 mm/second, at least about 25 mm/second, at least about 50 mm/second, at least about 75 mm/second or at least about 125 mm/second. In addition, the nozzle 108 of the additive manufacturing system 100 can move along the rails 120, 122 at a speed no greater than about 400 mm/second, no greater than about 350 mm/second, no greater than about 300 mm/second, no greater than about 250 mm/second, no greater than about 200 mm/second, or no greater than about 150 mm/second. In an illustrative example, the nozzle 108 of the additive manufacturing system 200 can move along the rails at a speed included in a range of about 2 mm/second to about 500 mm/second. In another illustrative example, the nozzle 108 can move along the rails 120, 122 at a speed included in a range of about 20 mm/second to about 300 mm/second. In an additional illustrative example, the nozzle 108 of the additive manufacturing system 200 can move along the rails at a speed included in a range of about 30 mm/second to about 100 mm/second.

The build material supply 116 can include any suitable material for forming the object 104. For example, the build material supply 116 can include a polymeric material. In some cases, the build material supply 116 can include a thermoplastic polymer. The build material supply 116 can also include a polyester. Additionally, the build material supply 116 can include a glycol-modified polyethylene terephthalate. Further, the build material supply 116 can include a copolymer. To illustrate, the build material supply 116 can include a copolyester. The build material supply 116 can also include polylactic acid, acrylonitrile butadiene styrene, a polycarbonate, a polyamide, a polyetherimide, a polystyrene, a polyphenylsulfone, a polysulfone, a polyethersulfone, a polyphenylene, a poly(methyl methacrylate), or a combination thereof.

The materials used to form the object 104 can include various additives. For example, the build material used to produce the object 104 can include pigment or dye to alter a color of the build material. The build material can also include other additives that affect the optical properties of the object 104.

As build material is supplied to the extrusion head 108, the controller 106 directs the movement of the extrusion head 108 along horizontal guide rails 120 and/or vertical guide rails 122 so that the extrusion head 108 can follow a predetermined build path while depositing build material for each layer of the object 104. In this sense, the guide rails 120 and 122, such as a gantry, allow the extrusion head 108 to move two-dimensionally and/or three-dimensionally in vertical and/or horizontal directions as shown by the arrows in FIG. 1. Additionally, or alternatively, the platform 114 can be movable in two-dimensions and/or three-dimensions, and such movement can be controlled by the controller 106 to provide similar relative movement between the substrate 110 and platform 114 and the extrusion head 108 so that multiple roads of build material can be deposited by moving the extrusion head 108 and/or the platform 114 in a two-dimensional (2D) horizontal plane (i.e., X-Y plane) to form each layer of the object 104, and then multiple successive layers can be deposited on top of one another by moving the extrusion head 108 and/or the platform 114 in a vertical Z-direction.

The object 104 can be formed in a controlled environment, such as by confining individual ones of the components of the system 100 (e.g., the substrate 110, the extrusion head 108 and the nozzle 112, etc.) to a chamber or other enclosure where temperature, and perhaps other parameters (e.g., pressure) can be controlled and maintained at a desired level by elements configured to control temperature, pressure, etc. (e.g., heating elements, pumps, etc.). In some instances, the temperature applied to the build material can correspond to a temperature at or above the creep-relaxation temperature of the build material. This can allow more gradual cooling of the build material as it is deposited onto the substrate 110 so as to prevent warping of the layers of the object 104 upon deposition. On the other hand, an environment that is maintained at a temperature that is too high for a given build material can cause the build material formed on the substrate 110 to droop before it is solidified in the object 104, potentially causing distortions in the final shape of the object 104.

Additionally, the platform 114 can be heated. For example, the platform 114 can be heated at a temperature of at least about 35° C., at least about 45° C., or at least about 60° C. In another example, the platform 114 can be heated at a temperature no greater than about 120° C., no greater than about 110° C., no greater than about 100° C., no greater than about 85° C., or no greater than about 70° C. In an illustrative example, the platform 114 can be heated at a temperature included in a range of about 30° C. to about 125° C. In another illustrative example, the platform 114 can be heated at a temperature included in a range of about 40° C. to about 90° C. Heating the platform 114 can promote an anti-warping effect on the build material used to form the object 104. Heating of the platform 114 can be performed by any suitable heating elements, such as electrical elements that can be turned on or off, gas heating elements below the platform 114, or any other suitable heating element. In some situations, the platform 114 may not be heated and the platform 114 can have a temperature included in a range of about 15° C. to about 30° C. The glass transition temperature, T_{g}, of the substrate 110 can be higher than the temperature at which the platform 114 is heated to minimize and/or eliminate melting of the substrate 100 and fusion between the substrate 100 and the build material. In some examples, the glass transition temperature, T_{g}, of the substrate can be included in a range of about 105° C. to about 120° C.

As will be described in more detail below with reference to the following figures, the material of the substrate 110 is generally immiscible with the build material used to form the object 104, yet a relationship between the material properties of the build material and the material of the substrate can be selected in order to promote optimal adhesion characteristics between the substrate 110 and the build material deposited thereon. The term “immiscible,” as used herein, refers to two or more materials that do not exhibit intimate interactions upon mixing of the two or more materials on a molecular level such that a significant proportion of a blend or composite of the two or more materials does not form a homogeneous solution. In particular, two materials can be immiscible in the absence of an interface between a phase of a first material and a phase of a second material. In some cases, two materials can be considered immiscible when a percent difference between respective Hildebrand Solubility Parameters of the two materials is at least about 5%. The percent difference between the two Hildebrand solubility values can be defined as a ratio of the difference between the two values and the average of the two values, shown as a percentage. In other words, the percent difference between the two values can be defined as the difference between the two values divided by the average of the two values, shown as a percentage. Equation (1) is an example of the percent difference calculation:

$$Percent Difference = \frac{\vert {HS}_{1} - {HS}_{2} \vert}{( \frac{{HS}_{1} + {HS}_{2}}{2} )} \times 100 \% \qquad Eq . ( 1 )$$

In Equation (1), HS₁ can represent the Hildebrand solubility parameter of the substrate 110 material, and HS₂ can represent the Hildebrand solubility parameter of the object 104 material, or vice versa.

Two or more thermoplastic polymers can also be considered to be immiscible when a blend or composite of the polymers exhibits a visibly-detectable level of haze when viewed at various angles either with or without backlighting. By contrast, two thermoplastic polymers are considered to be miscible if the polymers mix in substantially all proportions to form a homogeneous solution

A Hildebrand solubility parameter of the build material can be at least about 7, at least about 8, or at least about 9. In addition, the Hildebrand solubility parameter of the build material can be no greater than about 13, no greater than about 12, no greater than about 11, or no greater than about 10. In an illustrative example, the Hildebrand solubility parameter of the build material can be included in a range of about 6 to about 13. In another example, the Hildebrand solubility parameter of the build material can be included in a range of about 9 to about 11. In other examples, the Hildebrand Solubility parameter of the build material can be included in a range of about 10 to about 11.

Additionally, a Hildebrand solubility parameter of the substrate 110 can be at least about 8, at least about 9, at least about 10, or at least about 11. Further, the Hildebrand solubility parameter of the substrate can be no greater than about 12, no greater than about 11, no greater than about 10, or no greater than about 9. In an example, the Hildebrand solubility parameter of the substrate 110 can be included in a range of about 5 to about 14. In another example, the Hildebrand solubility parameter of the substrate 110 can be included in a range of about 10 to about 11. The Hildebrand solubility parameter of the build material and the substrate 110 can be expressed in units of (cal-cm⁻³)^{0.5}.

Further, a percent difference between the Hildebrand solubility parameter of the substrate 110, and the Hildebrand solubility parameter of the object 104 can be at least about 5%, at least about 10%, or at least about 15%. The percent difference between the Hildebrand solubility parameter of the substrate 110, and the Hildebrand Solubility parameter of the object 104 can also be no greater than about 35%, no greater than about 30%, no greater than about 25% or no greater than about 20%. In an illustrative example, the percent difference between the Hildebrand solubility parameter of the substrate 110, and the Hildebrand solubility parameter of the object 104 can be included in a range of about 5% to about 40%. In another illustrative example, the percent difference between the Hildebrand solubility parameter of the substrate 110, and the Hildebrand solubility parameter of the object 104 can be included in a range of about 5% to about 15%. In an additional illustrative example, the percent difference between the Hildebrand solubility parameter of the substrate 110, and the Hildebrand solubility parameter of the object 104 can be included in a range of about 8% to about 22%.

Adhesion characteristics between the initial layers of the object 104 and the surface of the substrate 110 can be created such that the object 104 will not move about the substrate 110 during formation of the object 104, yet the object 104 can be easily removed from the substrate 110 without mechanically contacting the object 104 with a device, chemically contacting the object 104, and/or thermal/temperature cycling. As will be discussed in more detail below with reference to the following figures, such adhesion characteristics can be influenced by a relationship between respective surface energies of the substrate 110 and the first layer(s) of the object 104, as well as by a relationship between the Hildebrand solubility parameters of the substrate 110 and the first layer(s) of the object 104. In an example, an individual can remove the substrate 110 from the system 100 after the object 104 has been produced on the substrate 110, and then the individual can flex the substrate 110 by applying a force with the hands of the individual to two or more edges of the substrate 110. In some cases, the individual can apply a force to opposite ends of the substrate 110 to cause the substrate 110 to flex in a vertical direction. By flexing the substrate 110, the attachment between the object 104 and the substrate 110 can be reduced such that the object 104 can “pop off” or otherwise be removed from the substrate 110. After removal from the substrate 110, the object 104 can be packaged or otherwise processed by downstream systems. By forming the object 104 on the substrate 110 as described with respect to implementations described herein, the object 104 can be removed from the substrate 110 with minimal or no damage to the object 104 and to the substrate 110. Thus, the substrate 110 can be re-used or recycled after removal of the object 104 therefrom such that another object 104 can be formed on the same substrate 110.

Although FIG. 1 illustrates one illustrative example of certain components of an additive manufacturing system usable for carrying out the techniques disclosed herein, it is to be appreciated that the configuration and inclusion of certain components shown in FIG. 1 is one, non-limiting, example of a suitable additive manufacturing system. Namely, other types and configurations of additive manufacturing systems can be utilized with the techniques and materials disclosed herein without changing the basic characteristics of the additive manufacturing system 100, and the additive manufacturing system 100 can be implemented as any suitable size for a particular industry or application, such as industrial-sized for commercial object production and/or testing, desktop-sized, handheld for consumer-use, and so on. For example, a handheld additive manufacturing system can be utilized to form the object 104 on the substrate 110. One illustrative example of a suitable handheld system is the 3Doodler®, a 3D printing pen from WobbleWorks LLC.

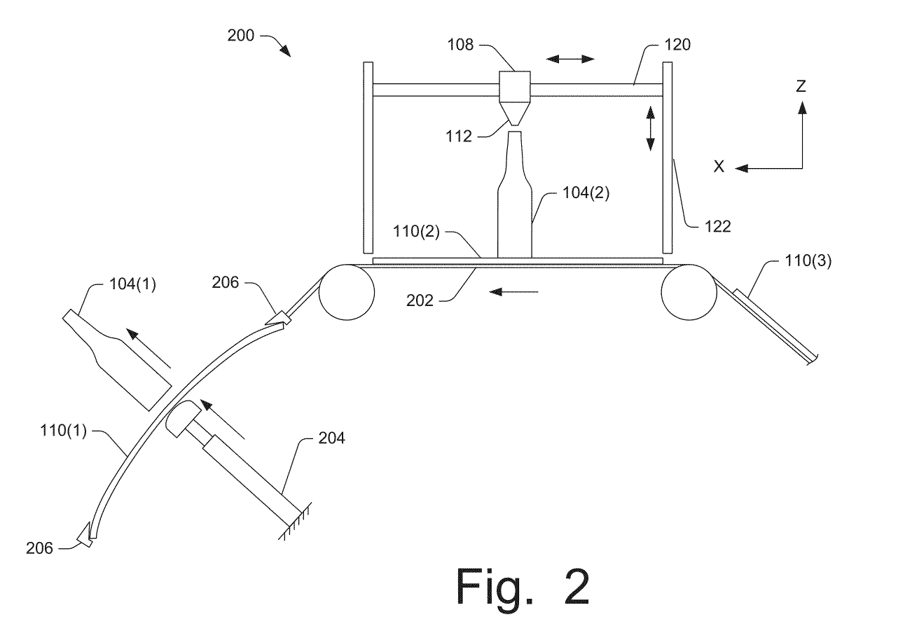

FIG. 2 illustrates example components of an example additive manufacturing system 200 according to another example. In FIG. 2, the platform 114 of FIG. 1 is more or less replaced with a conveyor system 202 that carries substrates 110(1), 110(2), 110(3), etc., on the conveyor system 202 and positions the substrates, such as the substrate 110(2), under the extrusion head 108 for printing of one or more objects 104(1) and 104(2) thereon and subsequently moving the conveyor system 202 in order to position a successive substrate under the extrusion head 108 to print another one or more objects thereon. In such a configuration, it is contemplated that the extrusion head 108 can be provided at one location over the conveyor and an object removal mechanism 204 (e.g., an actuating arm, piston, hydraulic) can be positioned downstream from the extrusion head 108 to remove the object from the substrate 110 after the objects 104(1) and 104(2) are printed thereon. FIG. 2 shows the object removal mechanism 204 applying a force to a bottom side of the substrate 110(1) in a direction that is substantially perpendicular to the bottom side of the substrate 110(1) while the ends of the substrate 110(1) are held substantially in place by clamps 206. The substrate 110(1) may be moved by the conveyor system 202 into a position where the claims 206 may move over the substrate 110(1) to hold the ends of the substrate 110(1) (e.g., the clamps 206 may be retractable/movable). In this position, the substrate 110(1) may no longer be positioned on a conveyor of the conveyor system 202, as the object removal mechanism 204 may contact the underside of the substrate 110(1) directly. The three-point flexing of the substrate 110(1) causes the object 104(1) to dislodge from the substrate 110(1) without mechanically contacting the object 104(1) with a device (e.g., the object removal mechanism 204) or chemically contacting the object 104(1). For example, the object removal mechanism 204 contacts an underside of the substrate 110(1) opposite the surface on which the object 104(1) was formed so that the object removal mechanism 204 does not contact the object 104(1) during removal of the object 104(1).

In some examples, the substrates 110(1), 110(2), and 110(3) have just recently been formed at a station that is upstream from the system 200 such that the substrates 110(1), 110(2), and 110(3) are still “hot” from their manufacturing process upon reaching the system 200. This can enable reduction of an environmental temperature of the system 200.

In some examples, the extrusion head 108 can be provided on rigid or semi-rigid guide rails, such as the guide rails 120 and 122 shown in FIGS. 1 and 2, while in other examples, the extrusion head 108 can be provided on a robotic arm. For example, delta robots or other suitable robotic arms can be positioned over the conveyor system 202 and can be controlled by the controller 106 to carry out the additive manufacturing process and material removal features disclosed herein.

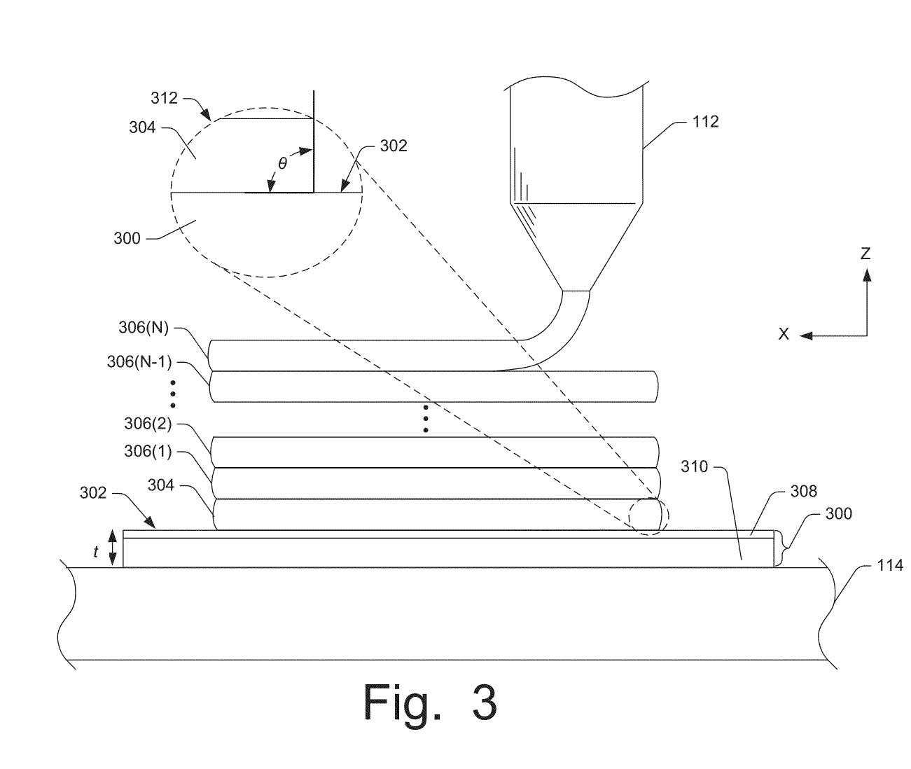

FIG. 3 illustrates a close-up, side view of multiple layers of an example object, such as the object 104, being deposited onto an example substrate 300 during an additive manufacturing process. The substrate 300 is shown in FIG. 3 as having a thickness, t, and being supported by a portion of the platform 114. The substrate 300 can be removably attached or fastened to the platform 114 in any suitable manner, such as those described in detail with reference to FIG. 1.

As discussed above with reference to FIGS. 1 and 2, during the additive manufacturing process of forming an object 104 on the substrate 300, build material is supplied to the extrusion head 108 where it is heated and extruded out of the nozzle 112 so that the build material can be deposited in roads onto a surface 302 (e.g., a top surface) of the substrate 300. Accordingly, a first layer 304 of build material is shown as being deposited directly onto the surface 302 of the substrate 300 according to a predetermined build path, which can represent a beginning of the additive manufacturing process.

As the nozzle 112 moves at a predetermined speed according to a build pattern, multiple additional layers 306(1), 306(2), . . . , 306(N−1), 306(N) of the build material can be deposited in a layer-by-layer fashion to form the object 104 on the substrate 300. As the layers 306(1)-(N) of build material are added to previously deposited layers, the object 104 is formed. The object 104 can be formed with 100% infill (i.e., a solid object 104), or with at least a partially hollow interior portion of the object 104 (i.e., something less than 100% infill).

The layer height, or thickness (in the Z-direction of FIG. 3), of each of the first layer 304, and the multiple additional layers 306(1)-(N) can be of any suitable height/thickness to provide the desired “resolution” to the finished object 104. That is, thicker layers may result in a noticeably rigid or jagged outer surface of the object 104 (i.e., lower resolution object), while thinner layers may make the separate layers inconspicuous and the object 104 may have a smoother outer surface in both appearance and feel. Furthermore, each of the first layer 304, and the multiple additional layers 306(1)-(N) can be of uniform height or of varying heights. The layer height of any individual layer (i.e., the first layer 304 and/or the multiple additional layers 306(1)-(N)) can be at least about 0.1 mm, at least about 0.15 mm, at least about 0.2 mm, or at least about 0.25 mm. Additionally, the layer height of any individual layer can be no greater than about 1 mm, no greater than about 0.75 mm, no greater than about 0.5 mm, no greater than about 0.4 mm, no greater than about 0.35 mm, or no greater than about 0.3 mm. In an illustrative example, a layer height of any individual layer can be included in a range of about 0.1 mm to about 0.4 mm.

In the example of FIG. 3, the substrate 300 is shown as having at least a top layer 308 (“surface layer 308”) that is made of a first material, such as any of the thermoplastic polymers described above. The substrate 300 shown in FIG. 3 can be manufactured by coating a main portion 310 or body of the substrate 300 with a first material (e.g., a thermoplastic polymer) to form the top layer 308. Alternatively, substantially all of the substrate 300 may be made of the first material, such as any of the thermoplastic polymers described above.

Both of the first material of the substrate 300 and the build material of at least the first layer 304 of the object 104 can be selected to promote good adhesion at the interface between the surface 302 of the substrate 300 and the first layer 304 during the formation of the object 104. Particularly, sufficient wetting can occur at the interface between the surface 302 of the substrate 300 and the first layer 308 of the object 104 as the build material is deposited on the surface 302. “Wetting,” or the wettability of the surface 302 by the build material, in this scenario can be measured by a contact angle, θ, as shown in the close-up view 312 in FIG. 3, which is indicative of the extent to which the first layer 304 of build material covers the surface 302 in terms of contact area on the substrate 300. In the close-up view 312, the contact angle, θ, is approximately 90°, indicating that the first layer 304 wets the substrate 300 to a significant degree. In general, the smaller the contact angle, θ, the better the wetting (i.e., increased contact area between the surface 302 and the build material). A contact angle, θ, included in a range between about 0° and about 90° is indicative of high wetting, whereas a contact angle, θ, included in a range between about 90° and about 180° is indicative of low wetting.

The surface energy of the substrate 300 and the surface energy of the first layer 304 of build material can be selected to achieve the high wetting condition noted above. Surface energy (or surface free energy) can be defined as the reversible work per unit area needed to create a new surface of a solid. For instance, if at least the surface 302 of the substrate 300 has a first surface energy, the build material of the first layer 304 may be selected to have a second surface energy such that a percent difference between the first surface energy and the second surface energy is within about 10%. In this sense, the first material of the substrate 300 at its surface 302 and the second material of the first layer 304 of build material may have “similar” surface energies (within about 10% of each other), and this similarity can promote wetting, which in turn creates sufficient adhesion during the formation of the object 104 so that the object 104 does not move about the substrate 300 during its formation. The abovementioned wetting condition can be created even in the absence of a heated platform/substrate (e.g., heated above ambient temperature, such as about 90° C.).

More complete wetting can occur if the substrate 300 has a much higher surface energy than the build material, but this may in turn promote a permanent bond at the interface between the surface 302 of the substrate 300 and the first layer 304 of the object 104. Since the object 104 is to be removed from the substrate 300 upon completion of the object 104, the adhesion characteristics may be refined by the surface energy relationship noted above. Furthermore, the first material of the substrate 300 and the build material of at least the first layer 304 of the object 104 can be selected to prevent chain entanglements at the interface for ensuring that a permanent bond is not created at the interface between the surface 302 of the substrate 300 and the first layer 304 of the object 104. One example technique for selecting suitable materials to accomplish such adhesion characteristics is to select materials having a particular relationship between their respective Hildebrand solubility parameters. For example, if the first material of the substrate 300 has a first Hildebrand solubility parameter and the second material of the first layer 304 of the object 104 has a second Hildebrand solubility parameter, a percent difference between the first Hildebrand solubility parameter and the second Hildebrand solubility can be at least about 5%. Such a Hildebrand solubility parameter relationship between the first and second materials at the object-substrate interface enables a completed object 104 to be easily removed from the substrate 300 without physically contacting the object 104 with a device or chemically contacting the object 104 (e.g., flexing the substrate 300). Therefore, the substrate 300 can be configured to resiliently flex or bend in order to remove a completed object 104 from the substrate 300.

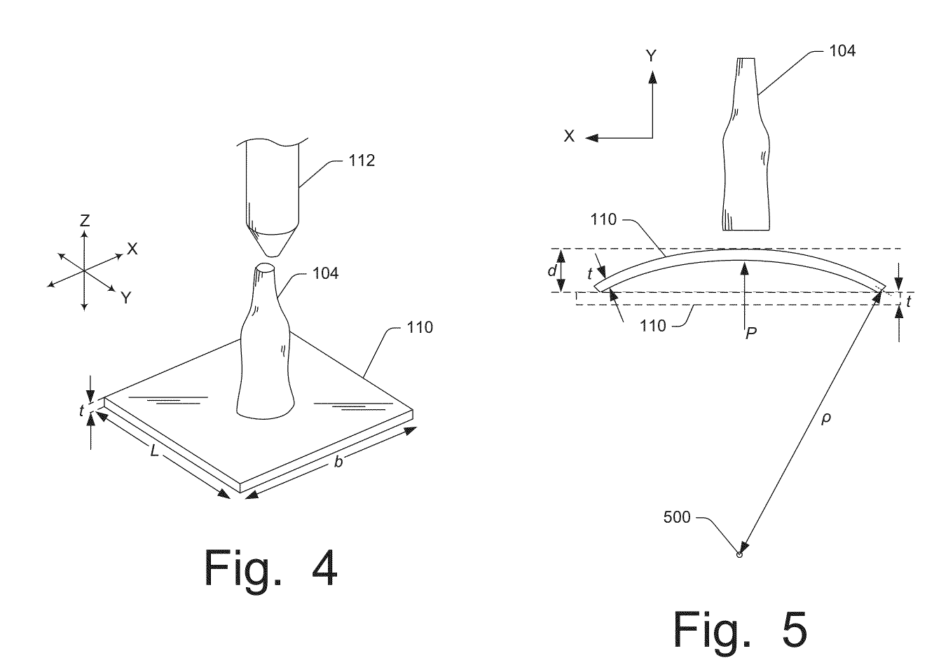

FIG. 4 illustrates a partial perspective view of example components of an example additive manufacturing system showing a completed object 104 that was formed on an example substrate 110, where the object 104 has been formed using the example additive manufacturing system. In the example shown in FIG. 4, the object 104 is bottle-shaped, although any conceivable object having a different shape can be formed with the additive manufacturing process. In some examples, multiple objects 104 may be formed on a single substrate, such as the substrate 110, using an additive manufacturing system, such as the additive manufacturing system 100 of FIG. 1. In this manner a plurality of objects 104 may be formed simultaneously or in sequence upon the same substrate 110 for improved efficiency.

The substrate 110 may be substantially made of a first material, or the substrate may at least comprise a surface layer 308 of the first material, as shown in FIG. 3. In this manner, although the substrate 110 of FIG. 1 is shown in FIGS. 4 and 5, the substrate 100 shown in FIGS. 4 and 5 can be either the substrate 110 or the substrate 300. FIG. 4 illustrates the substrate 110 having dimensions of thickness, t, length, L, and width, b. These dimensions of the substrate 110 can vary depending on the first material of the substrate 110. The dimensions can be selected to facilitate bending or flexing of the substrate 110 in a resilient manner as shown in FIG. 5. Resiliency in this context means that the substrate 110 can return substantially to the lowest potential energy state shown in FIG. 4 after being bent or flexed, as shown in FIG. 5. The substrate 110 can also be of various shapes, including square, circular, rectangular, triangular, or any suitable polygonal shape.

Accordingly, FIG. 5 illustrates a side elevation view of the substrate 110 and the object 104 of FIG. 4 showing an example technique for removal of the object 104 from the substrate 110. Specifically, FIG. 5 shows the substrate 110 being flexed or bent in three-point bending, causing the object 104 to dislodge from the substrate 110. The ability for the object 104 to “pop off” or otherwise substantially dislodge from the substrate 110 can be influenced by the adhesion characteristics at the interface between the object 104 and the substrate 110, as discussed above. For instance, if at least the surface 302 of the substrate 110 has a first Hildebrand solubility parameter, and at least a first layer 304 of the build material of the object 104 has a second Hildebrand solubility parameter, a percent difference between the first Hildebrand solubility parameter and the second Hildebrand solubility can be at least about 5%. In this manner, chain entanglements can be minimized or inhibited at the interface between the surface 302 of the substrate 110 and the first layer 304 of the object 104. Thus, the dissimilarity of the Hildebrand solubility parameters between the substrate 110 and the object 104 facilitate, at least in part, the removal of the object 104 from the substrate 110 after the object 104 is formed thereon. In fact, as shown in FIG. 5, the object 104 can be removed without mechanically contacting the object 104 with a device (e.g., a tool such as a chisel, blade, etc.) or chemically contacting the object 104 (e.g., chemically dissolving material at an interface between the object 104 and the substrate 110), which is often necessary when the adhesion strength between the object 104 and the substrate 110 is too strong. In the example of FIG. 5, removal of the object 104 from the substrate 110 is accomplished by flexing or bending the substrate 110 (e.g., by application of force by a human operator or a machine such as the object removal mechanism 204 of FIG. 2), causing the object 104 to dislodge, or “pop-off” of the substrate 110. With optimal adhesion characteristics, the object 104 can delaminate from the substrate 110 without leaving a residue that is visible to the eye. In addition, the bottom of the object 104 can have a smooth finish that is aesthetically pleasing.

In order to perform the example object removal technique shown in FIG. 5, the substrate 110 can be configured to resiliently flex or bend at least in an amount of the center deflection distance, d, shown in FIG. 5. The ability for the substrate 110 to bend or flex elastically in the manner shown in FIG. 5 can be influenced by the first material of the substrate 110 and the dimensions (t, L, and b) of the substrate 110. It is known that different materials can have different stiffness in bending (rigidity or resistance to an applied load) measured by Hooke's Law in terms of stiffness (k)=load/deflection. The area moment of inertia, I, of the substrate 110 influences the stiffness of the substrate 110 in bending. In general, the higher the area moment of inertia, I, the less the substrate 110 will deflect and the stiffer the substrate 110 will be. Equations for area moment of inertia, I, are known for various cross-sectional geometries. For a rectangular cross-sectional geometry, such as the cross-section shown in FIG. 4 represented by the b×t rectangular area, the area moment of inertia, I, can be calculated as:

$$I = \frac{1}{12} {bt}^{3} \qquad Eq . ( 2 )$$

Equation 2 illustrates that a thicker substrate 110 (i.e., relatively larger value of t) will cause the substrate 110 to be stiffer in bending when subjected to the flexing shown in FIG. 5. The material of the substrate 110 can also influence its stiffness in bending, such as the bending shown in FIG. 5. The modulus of elasticity, E, (Young's modulus) of a given material is a measure of material's deformation under a load, which is therefore a measure of its stiffness. In general, the higher the value of the modulus of elasticity, E, of a material, the less the substrate 110 of that material deflects, meaning a higher stiffness.

Thus, with the above material properties in mind, the center deflection, d, of the substrate 110 under a load, P, can be characterized by Equation 3:

$$d = \frac{{PL}^{3}}{48 EI} \qquad Eq . ( 3 )$$

In some examples, the substrate 110, in order to cause the object 104 to be dislodged from the substrate 110, can be configured to flex in three-point bending with a center deflection, d, of at least about 12 mm. Moreover, since the substrate 110 is to be reused for repeatedly forming objects 104 thereon, the flexural strength, R, of the substrate 110 can be selected to be of an amount where the maximum applied load, Pₘₐₓ, at the point of fracture (or plastic deformation for materials that deform plastically before fracture) of the substrate 110, is greater than the load, P, on the substrate 110 causing the center deflection, d, of at least about 12 mm. The condition of P being less than Pₘₐₓ in this scenario means that the substrate 110 can deform elastically to achieve the center deflection, d. Flexural strength, R—for the rectangular cross-section geometry of the substrate 110 in FIG. 4—can be measured by Equation 4 as:

$$R = \frac{3 P max * L}{2 {bt}^{2}} \qquad Eq . ( 4 )$$

Thus, for a given substrate 110 made of a first material and having dimensions L, b, and t, as shown in FIG. 4, the maximum applied load, Pₘₐₓ, of Equation 4 is to be greater than the applied load, P, that results in the center deflection, d, of at least about 12 mm according to Equation 3. In other words, the substrate 110, under the load, P, is to deform elastically (i.e., P<Pmax) at least to the minimum center deflection, d, and subsequently return to its original shape (i.e., lowest potential energy state) when the load, P, is removed. In this manner, at least some resilient flexing of the substrate 110 may occur during removal of the object 104, as shown in FIG. 5.

In some cases, a length, L, of the substrate 110 can be at least about 40 mm, at least about 80 mm, at least about 120 mm, or at least about 150 mm. Additionally, the length, L, of the substrate 110 can be no greater than about 500 mm, no greater than about 400 mm, no greater than about 300 mm, no greater than about 250 mm, or no greater than about 200 mm. In an illustrative example, the length, L, of the substrate 110 can be included in a range of about 30 mm to about 600 mm. In another illustrative example, the length, L, of the substrate 110 can be included in a range of about 40 mm to about 250 mm. In an additional illustrative example, the length, L, of the substrate 110 can be included in a range of about 50 mm to about 200 mm.

In some cases, the deflection characteristics of the substrate 110 under the applied load, P, at a point when the object 104 becomes dislodged from the substrate 110 can vary according to the length, L, of the substrate 110. Accordingly, an amount by which the substrate 110 bends before the object 104 becomes dislodged can be measured in terms of a radius of curvature, ρ, of the substrate 110 under the applied load, P. The radius of curvature, ρ, of the substrate 110 is the radius of the circular arc which best approximates the curvature of the substrate 110 under an applied load, such as the applied load, P. A center 500 of an imaginary circle having a circular arc that best approximates the curvature of the substrate 110 under the applied load, P, is shown in FIG. 5. The radius of curvature, ρ, can span from the center 500 of the imaginary circle to the midpoint of the substrate 110 in terms of the thickness, t, of the substrate 110. As such, flexing the substrate 110 to cause removal of the object 104 from the substrate 110 can include flexing the substrate 110 in three-point bending to cause the flexed substrate 110 to have a radius of curvature, ρ, that is less than or equal to about 305 mm. In some examples, the radius of curvature to cause removal of the object 104 can be no greater than about 305 mm, no greater than about 250 mm, no greater than about 200 mm, no greater than about 150 mm, no greater than about 100 mm, no greater than about 80 mm, or no greater than about 40 mm. In some examples, the radius of curvature to cause removal of the object 104 can be included in a range of about 40 mm to about 150 mm.

Further, a width, b, of the substrate 110 can be at least about 35 mm, at least about 75 mm, at least about 125 mm, or at least about 160 mm. The width, b, of the substrate 110 can also be no greater than about 480 mm, no greater than about 390 mm, no greater than about 310 mm, no greater than about 250 mm, or no greater than about 210 mm. In an illustrative example, the width, b, of the substrate 110 can be included in a range of about 30 mm to about 600 mm. In another illustrative example, the width, b, of the substrate 110 can be included in a range of about 40 mm to about 250 mm. In an additional illustrative example, the width, b, of the substrate 110 can be included in a range of about 50 mm to about 200 mm. In some examples, a square-shaped substrate 110 can be about 100 mm in width, b, and about 100 mm in length, L.

Furthermore, in some examples, a thickness, t, of the substrate 110 can be at least about 0.5 mm, at least about 1 mm, or at least about 2 mm. Additionally, a thickness of the substrate 110 can be no greater than about 5 mm, no greater than about 4 mm, or no greater than about 3 mm. In an illustrative example, a thickness of the substrate 110 can be included in a range of about 0.7 mm to about 3 mm. In another illustrative example, a thickness of the substrate 110 can be include within a range of about 1 mm to about 2 mm.

When the substrate 300 of FIG. 3 having the top layer 308 and main portion 310 is utilized, the main portion 310 can be made of any suitable material that allows the substrate 300 to bend or flex resiliently, such as materials including, without limitation, pliable wood, metal, plastic, rubber, or any other suitably resilient material.

In some examples, the substrate 300 can comprise multiple layers of different material, such as a top layer 308, one or more intermediate layers, and a bottom layer. The top, intermediate, and bottom layers can allow for any combination of layers having different properties. So long as the substrate 300 is configured to flex or bend resiliently for enabling removal of the object 104 from the substrate 300 according to the techniques and systems herein, and so long as the top layer 308 is comprised of a suitable material to create optimal adhesion characteristics at the interface between a first layer 304 of the build material and the surface 302 of the substrate 300, the substrate 300 may be comprised of any number of different materials in any suitable laminar arrangement.

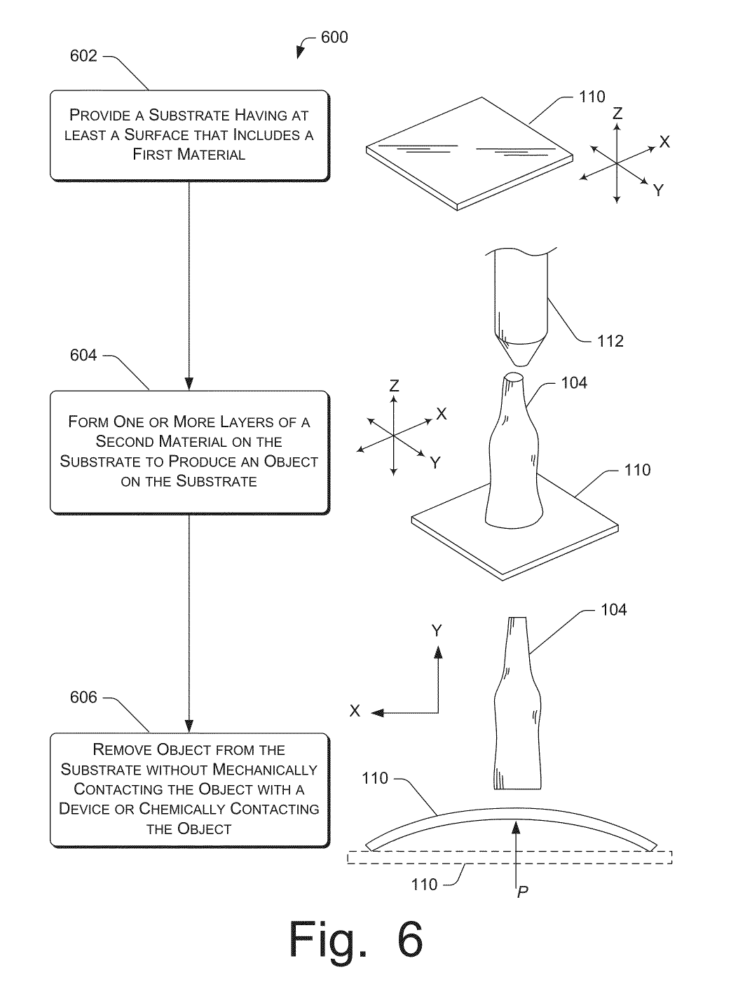

FIG. 6 is a flow diagram of an illustrative process 600 of forming an object, such as the object 104, on a substrate, such as the substrate 110 using an additive manufacturing system, such as the additive manufacturing system 100, and removing the object 104 from the substrate 110. The process is illustrated as a collection of blocks in a logical flow graph, which represent a sequence of operations that can be implemented, at least in part, by an extrusion-based additive manufacturing system. The order in which the operations are described is not intended to be construed as a limitation, and any number of the described blocks can be combined in any order and/or in parallel to implement the process. For discussion purposes, the process 600 is described with reference to the system 100 and components thereof that are described with reference to FIGS. 1-5.

At 602, a substrate, such as the substrate 110, can be provided for forming thereon an object. The substrate 110 can have at least a surface 302 that includes of a first material, such as those described in detail above, individually or in combination. For example, a top layer of the substrate 110, such as the top layer 308 shown in FIG. 3, including the first material can be formed (e.g., coated) on a main portion 310 of the substrate. Alternatively, the substrate 110 can be made entirely of the first material. In some examples, the providing the substrate 110 at 602 can comprise removably mounting or attaching a preformed substrate 110 to a platform, such as the platform 114. In other examples, providing the substrate 110 at 602 can further comprise creating the substrate 110 by a suitable manufacturing technique, such as injection-molding, extrusion (i.e., advancing the first material through a die), blow-molding, compression molding, casting, or any other suitable method of making the substrate 110.

At 604, a second material can be extruded onto a surface of the substrate 110 to produce an object 104. The substrate 110 may not be pretreated with a release agent or other chemicals prior to forming the object 104 thereon. In some examples, the forming of the one or more layers of the second material onto the substrate 110 occurs in predetermined patterns to build the object 104 in a layer-by-layer fashion according to 3D model data processed by the additive manufacturing system 100. In some examples, the first material of the substrate 110 has a first surface energy and a first Hildebrand solubility parameter, and the second material extruded onto the surface of the substrate 110 at 604 has a second surface energy and a second Hildebrand solubility parameter. A percent difference between the first Hildebrand solubility parameter and the second Hildebrand solubility is at least about 5%. Additionally in some cases, a percent difference between the first surface energy and the second surface energy is within about 10%. The relationships between surface energies and Hildebrand solubility parameters may promote sufficient adhesion between the substrate 110 and the layers of the second material during the formation of the object 104 at 604 while facilitating easy removal of the object 104 upon completion. In some examples, the forming at 604 is repeated on different portions of the substrate 110, such as when multiple objects 104 are to be formed on the same substrate 110.

At 606, the object 104 may be removed from the substrate 110 without physically contacting the object with a device (e.g., a chisel, blade, a person's hand, etc.) or chemically contacting the object 104 (e.g., chemically dissolving material at an interface between the object and the substrate). In an example, the removal of the object 104 at 606 can comprise flexing the substrate 110. The material of the substrate 110 can have a stiffness that allows for resilient (elastic) deformation up to at least a minimum center deflection, d, as shown in FIG. 5. In this manner, the object 104 can be removed from the substrate 110 with minimal, if any, damage to the substrate 110 and/or the object 104 and the substrate 110 can be re-used. Thus, the need for replacement substrates can be minimized or altogether eliminated.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

The concepts described herein will be further described in the following examples with reference to the following figures, which do not limit the scope of the disclosure described in the claims.

### EXAMPLES

### Example 1

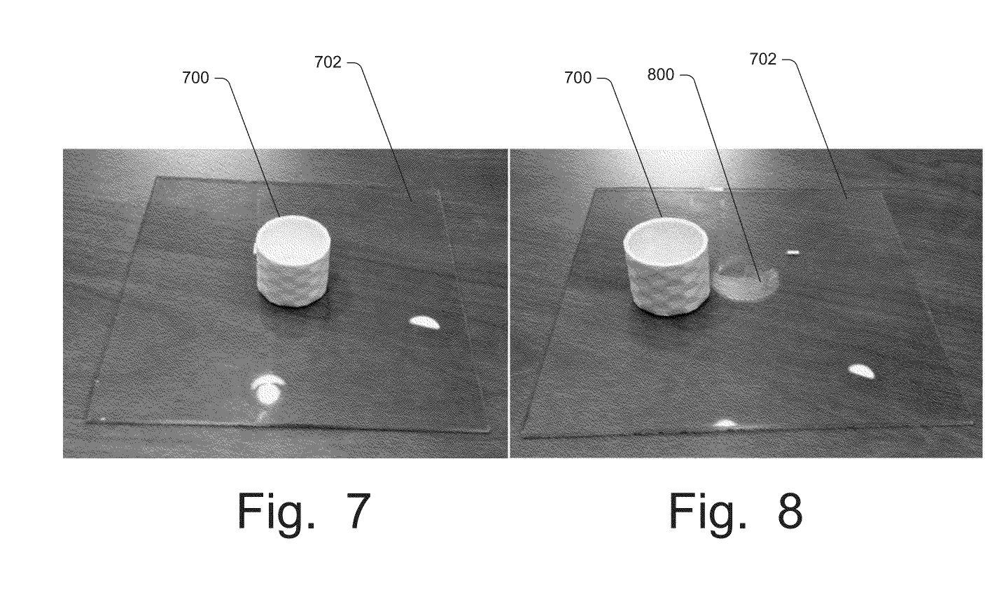

FIG. 7 shows an object 700 that was formed on a substrate 702 using an Afinia 3D printer. The object 700 was formed from an Amphora copolyester and the substrate 702 was formed from a Tritan TX1000 copolyester. The thickness of the substrate 702 was about 2 mm. The Afinia 3D printer was set at an extrusion head temperature of 250° C. with a 0.1 mm layer height and solid infill. The platform of the Afinia 3D printer was heated at a temperature of 90° C. during the formation of the object 700. FIG. 7 shows the object 700 after having been formed on the substrate 702. After forming the object 700 on the substrate 702, the object 700 was removed from the substrate 702 by an individual flexing two edges of the substrate 702 with their hands. FIG. 8 shows the object 700 after having been removed from the substrate 702. As shown in FIG. 8, the object 700 was not damaged after the removal from the substrate 702 and a minimum amount of residue 800 remained on the substrate 702 after the removal of the object 700.

### Example 2

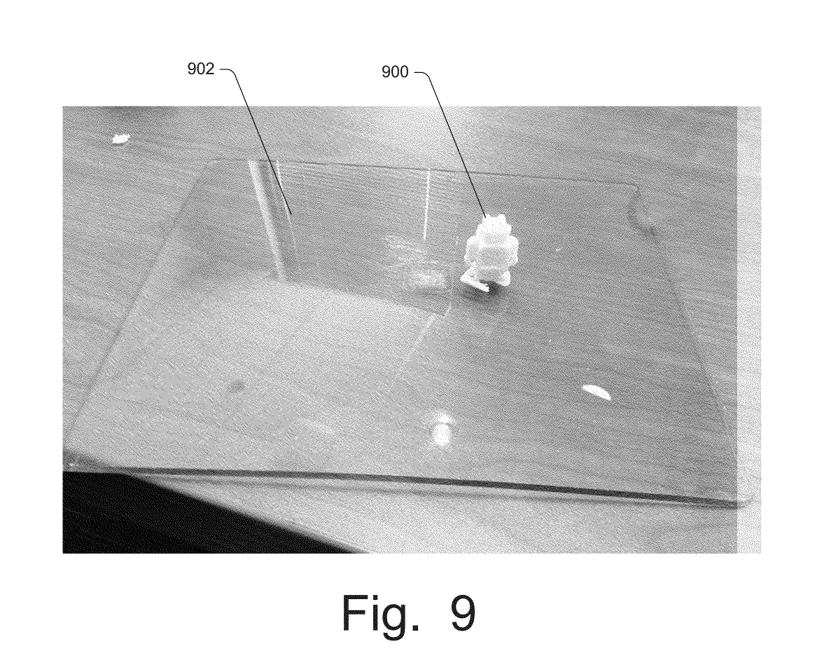

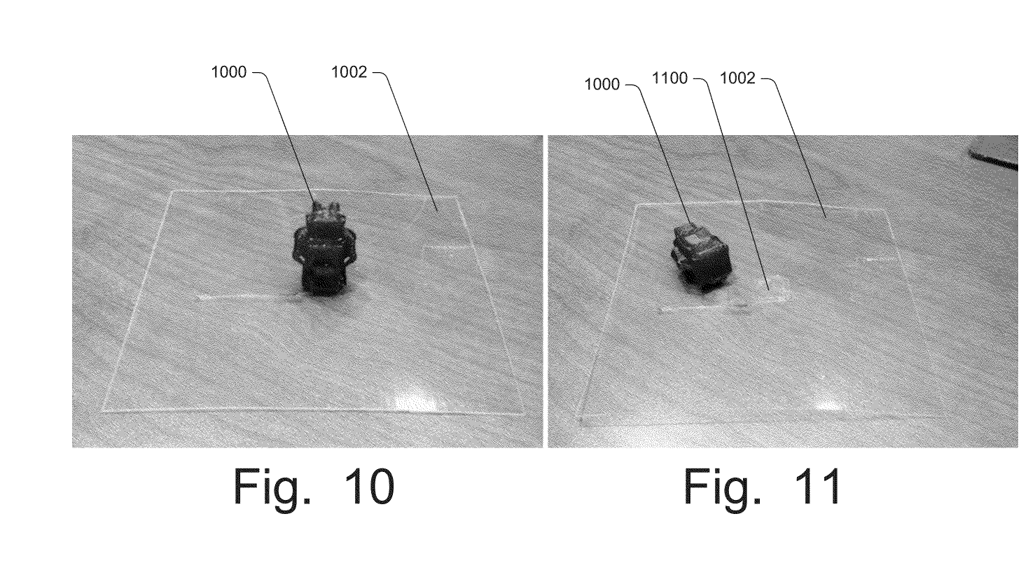

FIG. 9 shows an object 900 that was formed on a substrate 902 using an Ultimaker® 3D printer. The object 900 was formed from an Amphora copolyester and the substrate 902 was formed from a Tritan TX1000 copolyester. The thickness of the substrate 902 was about 4 mm. The Ultimaker® 3D printer was set at an extrusion head temperature of 245° C. with a 0.1 mm layer height and 100% infill. The platform of the Ultimaker® 3D printer was heated at a temperature of 90° C. during the formation of the object 900. After forming the object 900 on the substrate 902, an attempt was made to remove the object 900 from the substrate 902 by an individual flexing two edges of the substrate 902 with their hands, but the object 900 was not released from the substrate 902. The object 900 was removed from the substrate 902 using a blade (i.e., mechanically contacting the object 900). The substrate 902 was too thick to flex the substrate 902 by hands of an individual to a suitable radius of curvature or center point deflection to cause removal of the object 900 from the substrate 902 without mechanically contacting the object 900.

### Example 3

FIG. 10 shows an object 1000 that was formed on a substrate 1002 using an Ultimaker® 3D printer. The object 1000 was formed from an Amphora copolyester and the substrate 1002 was formed from a Tritan TX1000 copolyester. The thickness of the substrate 1002 was about 0.76 mm. The Ultimaker® 3D printer was set at an extrusion head temperature of 245° C. with a 0.1 mm layer height and 100% infill. No external heating was applied to the platform of the Ultimaker® 3D printer during the formation of the object 1000. After forming the object 1000 on the substrate 1002, the object 1000 was removed from the substrate 1002 by an individual flexing two edges of the substrate 1002 with their hands. The object 1000 was not damaged after the removal from the substrate 1002 and a minimum amount of residue remained 1100 on the substrate 1002 after the removal of the object 1000.

### Comparative Example 1

An attempt was made to form an object on a glass substrate using an Ultimaker® 3D printer. An Amphora copolyester was used in the attempt to form the object. The thickness of the substrate was about 10 mm. The Ultimaker® 3D printer was set at an extrusion head temperature of 260° C. with a 0.1 mm layer height and 100% infill. No external heating was applied to the platform of the Ultimaker® 3D printer. During the process to form the object, the base of the partially completed object became detached from the substrate. After the partially completed object was detached from the substrate, the partial object was dragged along the surface of the substrate by the nozzle of the 3D printer and the 3D printer was unable to complete the formation of the object. Without being tied to any particular theory, the differences between the physical characteristics of the substrate and the material of the object in addition to the lack of heating of the 3D printer platform may have prevented sufficient bonding to take place between the substrate and the material of the object. Thus, the object was prevented from being completely formed.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
removably mounting a preformed substrate to a platform, the preformed substrate having a surface including a first material, the first material having a first surface energy and a first Hildebrand solubility parameter;
forming one or more layers of a second material on the surface of the preformed substrate by an additive manufacturing process to produce an object comprised of the one or more layers of the second material, the second material having a second surface energy and a second Hildebrand solubility parameter, wherein a percent difference between the first Hildebrand solubility parameter and the second Hildebrand solubility parameter is at least about 5%, and wherein a percent difference between the first surface energy and the second surface energy is within about 10%; and
removing the object from the preformed substrate by flexing the preformed substrate.

2. The method of claim 1, wherein a bottom layer of the one or more layers is fixedly attached to the preformed substrate during the forming of the one or more layers.

3. The method of claim 1, wherein a thickness of the preformed substrate is included in a range of about 0.7 mm to about 3 mm.

4. The method of claim 1, wherein the first material and the second material are thermoplastic.

5. The method of claim 4, wherein the first material includes a first copolyester and the second material includes a second copolyester.

6. The method of claim 1, further comprising heating the platform to a temperature included in a range of about 35° C. to about 100° C.

7. The method of claim 1, wherein the additive manufacturing process forms the one or more layers of the second material according to a pattern that is predetermined by software code.

8. The method of claim 1, wherein the flexing the preformed substrate comprises flexing the preformed substrate in three-point bending to cause: (i) a center of the preformed substrate to deflect under elastic deformation in an amount of at least about 12 mm, or (ii) the preformed substrate to have a radius of curvature that is less than or equal to about 305 mm.

9. The method of claim 1, wherein the object comprises a first object, the method further comprising, after the removing the object from the preformed substrate:
reusing the preformed substrate by forming one or more additional layers of the second material on the surface of the preformed substrate by the additive manufacturing process to produce a second object comprised of the one or more additional layers of the second material; and
removing the second object from the preformed substrate by flexing the preformed substrate.

10. The method of claim 1, wherein the flexing the preformed substrate is performed by a machine.

11. The method of claim 1, wherein, upon the removing the object from the preformed substrate, the object delaminates from the preformed substrate without leaving a residue that is visible to the eye.

12. The method of claim 1, wherein the preformed substrate is not pretreated with a release agent prior to the forming the one or more layers of the second material on the surface of the preformed substrate.

13. An additive manufacturing method comprising:
accessing three-dimensional (3D) model data indicating a pattern;
producing an object by depositing a material, layer-by-layer according to the pattern, on a surface of a substrate; and
removing the object from the substrate without mechanically contacting the object with a device or chemically contacting the object.

14. The additive manufacturing method of claim 13, wherein the removing comprises flexing the substrate to remove the object from the substrate.

15. The additive manufacturing method of claim 14, wherein the flexing the preformed substrate comprises flexing the preformed substrate in three-point bending to cause: (i) a center of the preformed substrate to deflect under elastic deformation in an amount of at least about 12 mm, or (ii) the preformed substrate to have a radius of curvature that is less than or equal to about 305 mm.

16. The additive manufacturing method of claim 13, wherein a thickness of the preformed substrate is included within a range of about 0.7 mm to about 3 mm.

17. A package containing a number of items for use in forming additive manufactured objects, the package including:
a sheet configured to elastically deform in response to a load applied to the sheet causing: (i) a deflection at a center of the sheet in an amount of at least about 12 mm, or (ii) the sheet to have a radius of curvature that is less than or equal to about 305 mm; and
an instruction for removing an additive manufactured object from the sheet without mechanically contacting the additive manufactured object with a device or chemically contacting the additive manufactured object.

18. The package of claim 17, wherein the instruction for removing the additive manufactured object comprises providing an instruction to flex the sheet in order to cause the additive manufactured object to dislodge from the sheet.

19. The package of claim 17, wherein the sheet is made of a first material having a first surface energy and a first Hildebrand solubility parameter, the package further comprising a filament of a second material for producing the additive manufactured object, the second material having a second surface energy and a second Hildebrand solubility parameter, wherein a percent difference between the first Hildebrand solubility parameter and the second Hildebrand solubility is at least about 5%, and wherein a percent difference between the first surface energy and the second surface energy is within about 10%.

20. A system comprising:
a three-dimensional (3D) printing machine;
a polymeric sheet having a thickness included within a range of about 0.7 mm to about 3 mm and being configured to elastically deform in response to a load applied to the sheet causing: (i) a deflection at a center of the sheet in an amount of at least about 12 mm, or (ii) the sheet to have a radius of curvature that is less than or equal to about 305 mm.

21. The system of claim 20, wherein the polymeric sheet is made of a thermoplastic polymer.

22. The system of claim 21, wherein the 3D printing machine is configured to deposit a second thermoplastic polymer, layer-by-layer, on a surface of the polymeric sheet to produce an object, and wherein the polymeric sheet is configured to deform in order to remove the object without mechanically contacting the object with a device or a chemical contacting the object and without thermal cycling.

23. The system of claim 20, wherein the polymeric sheet is removable from the 3D printing machine.

24. The system of claim 20, wherein the 3D printing machine comprises a nozzle of a dispenser head configured to deposit one or more layers of a material onto a surface of the polymeric sheet to produce an object, the system further comprising a conveyer configured to receive the polymeric sheet and to move the polymeric sheet underneath the nozzle for producing the object on the surface of the polymeric sheet.
